(19) United States
(12) Patent Application Publication
(10) Pub. No.: US 2026/0145444 A1
(43) Pub. Date: May 28, 2026

(54) RECORDING APPARATUS AND CUTTER ATTACHMENT METHOD

(71) Applicant: BROTHER KOGYO KABUSHIKI KAISHA, Nagoya (JP)

(72) Inventors: Wataru SUGIYAMA, Nishio (JP); Masatomo YAMAGUCHI, Inazawa (JP); Hideaki YOSHIMUNE, Nagoya (JP)

(73) Assignee: BROTHER KOGYO KABUSHIKI KAISHA, Nagoya (JP)

(21) Appl. No.: 19/395,066

(22) Filed: Nov. 20, 2025

(30) Foreign Application Priority Data
Nov. 22, 2024 (JP) 2024-203908

(51) Int. Cl. B41J 11/70; B41J 11/66; B41J 29/13

(52) U.S. Cl. CPC B41J 11/706; B41J 11/663; B41J 29/13

(57) ABSTRACT

A recording apparatus includes: a conveying unit; a recording unit; first and second cutters; and a casing. The first cutter is supported by the casing. The second cutter is attachable and detachable with respect to a carriage supported by the casing. The carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position. The second cutter is attachable to the carriage positioned at the non-contact position.

### REFERENCE TO RELATED APPLICATIONS

This application claims priority from Japanese Patent Application No. 2024-203908 filed on Nov. 22, 2024. The entire content of the priority application is incorporated herein by reference.

### BACKGROUND ART

A printer (recording apparatus) that includes a conveying mechanism, a recording part, a fixed blade (first cutter), a rotary blade (second cutter), a casing, and a cover capable of opening and closing an opening of the casing is known. Regarding such a printer, a configuration in which the rotary blade is exposed to outside by locating the cover at an open position and the rotary blade can be manually moved for repairing or replacing in a case where a trouble occurs, is known. In such a configuration, the fixed blade (first cutter) is supported by the casing, whereas the rotary blade (second cutter) is detachable with respect to the casing.

### SUMMARY

In the configuration as in the above-described printer where the second cutter is attachable and detachable with respect to the casing, a blade of the second cutter might come into contact with the first cutter and be damaged, in a case where the second cutter transitions from a detached state in which the second cutter is detached from the casing to an attached state in which the second cutter is attached to the casing. In a case where the blade of the second cutter is damaged, this damage might adversely affect the cutting of a recording medium, leading to any inconvenience.

Therefore, an object of the present disclosure is to provide a recording apparatus and a cutter attachment method capable of reducing occurrence of damaging of the blade of the second cutter, in a case where the second cutter transitions from the detached state to the attached state in the configuration where the second cutter is attachable and detachable with respect to the recording apparatus.

An aspect of the present disclosure is a recording apparatus including: a conveying unit; a recording unit; a first cutter; a second cutter; and a casing. The recording apparatus is configured to convey a recording medium by the conveying unit, record an image on the conveyed recording medium by the recording unit, and cut the conveyed recording medium by the first cutter and the second cutter. The first cutter is supported by the casing. The second cutter is attachable and detachable with respect to a carriage supported by the casing. The carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position. The second cutter is attachable to the carriage positioned at the non-contact position.

An aspect of the present disclosure is a cutter attachment method for a recording apparatus. The recording apparatus includes a conveying unit, a recording unit, a first cutter, and a casing. The recording apparatus is configured to convey a recording medium by the conveying unit, record an image on the conveyed recording medium by the recording unit, and cut the conveyed recording medium by the first cutter. The first cutter is supported by the casing. A second cutter configured to cooperate with the first cutter to cut the recording medium is attachable to a carriage supported by the casing. The carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position. The method includes: moving the carriage to the non-contact position; and attaching the second cutter to the carriage positioned at the non-contact position.

An aspect of the present disclosure is a recording apparatus including: a conveying unit; a recording unit; a first cutter; and a casing. The recording apparatus is configured to convey a recording medium by the conveying unit, record an image on the conveyed recording medium by the recording unit, and cut the conveyed recording medium by the first cutter. The first cutter is supported by the casing. A second cutter configured to cooperate with the first cutter to cut the recording medium is attachable to a carriage supported by the casing. The carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position. The second cutter is attachable to the carriage positioned at the non-contact position.

According to the recording apparatus and the cutter attachment method of the present disclosure, the second cutter is to be attached to the carriage positioned at the non-contact position. As a result, in a case where the second cutter transitions from a detached state to an attached state, the blade of the second cutter does not come into contact with the first cutter, and thus occurrence of damaging of the blade of the second cutter can be reduced.

### BRIEF DESCRIPTION OF DRAWINGS

FIG. 1 is a perspective view of a printer.

FIG. 2 is a schematic side view illustrating the inner structure of the printer.

FIG. 3 is a perspective view illustrating a scanning mechanism and a cutter unit included in the printer.

FIG. 4A and FIG. 4B are views illustrating the positional relationship between a cutter 60 and a cutter 70 as seen from the front. FIG. 4A illustrates a situation in which the cutter 60 in a contact state moves in a cutting direction, and FIG. 4B illustrates a situation in which the cutter 60 transitions from a detached state to an attached state at an attachment position X in a casing.

FIG. 5A and FIG. 5B are side cross-sectional views illustrating a process in which the cutter unit transitions from the detached state to the attached state.

FIG. 6 is a partial cross-sectional view of the cutter unit as seen from below.

FIG. 7A to FIG. 7C illustrate the positional relationship between a cutter 60 and a cutter 270 in a case where a printer is seen from the front. FIG. 7A is a diagram illustrating a situation in a case where the cutter 60 transitions from the detached state to the attached state at the attachment position X in the casing; FIG. 7B is a diagram illustrating a situation in a case where the cutter 60 in the contact state moves in the cutting direction; and FIG. 7C is a diagram illustrating a situation in a case where the cutter 60 moves in a direction opposite to the cutting direction and comes into contact with the circumferential surface of a roller.

FIG. 8A to FIG. 8C illustrate the positional relationship between a cutter 60 and a cutter 270 in a case where a printer is seen from the front. FIG. 8A is a diagram illustrating a situation in a case where the cutter 60 transitions from the detached state to the attached state at the attachment position X in the casing; FIG. 8B illustrates a situation in a case where the cutter 60 in the contact state moves in the cutting direction; and FIG. 8C illustrates a situation in a case where the cutter 60 moves in a direction opposite to the cutting direction and comes into contact with a chute member.

FIG. 9A to FIG. 9C illustrate the positional relationship between a cutter 60 and a cutter 470 in a case where a printer is seen from the front, in a direction orthogonal to a first direction D1. FIG. 9A is a diagram illustrating a situation in a case where the cutter 60 transitions from the detached state to the attached state at the attachment position X in the casing; FIG. 9B is a diagram illustrating a situation in a case where the cutter 60 in the contact state moves in the cutting direction; and FIG. 9C is a diagram illustrating a situation in a case where the cutter 60 moves in the direction opposite to the cutting direction and comes into contact with an inclined surface.

### DESCRIPTION

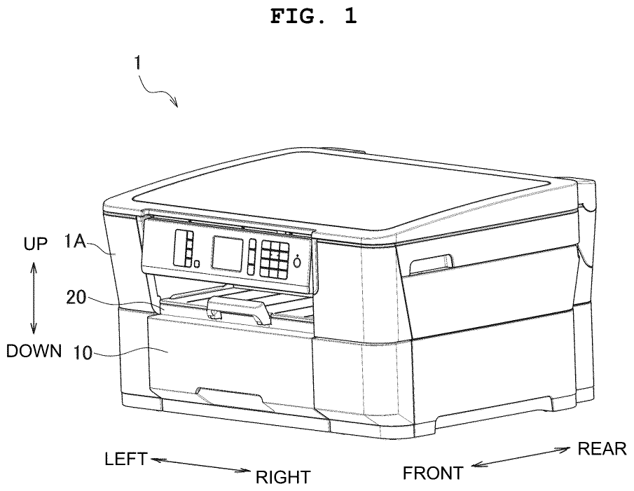

A printer 1 according to a first embodiment of the present disclosure includes a casing 1A, a sheet feed tray 10 which is detachable with respect to the casing 1A, and a sheet discharge tray 20, as illustrated in FIG. 1. The printer 1 is an example of a “recording apparatus” of the present disclosure.

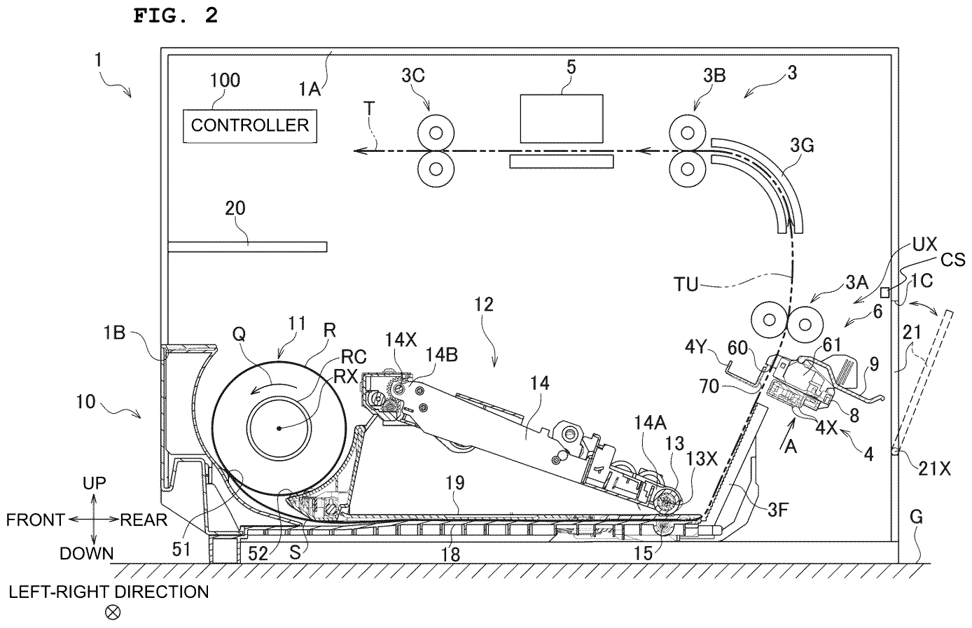

The printer 1 further includes a conveying mechanism (conveying unit) 3, a head 5, a cutter unit 6, a cutter 70, a scanning mechanism 4, and a controller 100, as illustrated in FIG. 2. The conveying mechanism 3, the head 5, the cutter unit 6, the scanning mechanism 4, and the controller 100 are supported by the casing 1A.

In the following description, the up-down direction is defined based on a state that the printer 1 is installed in a usable state on an installation surface G (the state illustrated in FIG. 2); the front-rear direction is defined such that the side where an opening 1B of the casing 1A is formed is defined as the front side (front surface or forward), and the side where an opening 1C of the casing 1A is formed is defined as the rear side (back surface or rearward). The left-right direction is defined, with the printer 1 being seen from the front side. The left-right direction is an example of a “first direction” of the present disclosure.

The conveying mechanism 3 is configured to convey a sheet S in a conveyance direction along conveyance route T, and includes a roller 13, an arm 14, roller pairs 3A to 3C, a separating member 3F, a pair of guide members 3G, and a conveying motor (not illustrated in the drawings) configured to drive each of the above-described rollers.

The conveyance route T is a route which starts from the sheet feed tray 10, passes between the pair of guide members 3G, passes below the head 5, and extends toward the sheet discharge tray 20. The conveyance route T has a U-shaped portion TU upstream of the head 5 in the conveyance direction. The separating member 3F, the cutter unit 6, the cutter 70, the roller pair 3A, and the pair of guide members 3G are positioned in the U-shaped portion TU. The cutter unit 6, the cutter 70, and the roller pair 3A are arranged at a bottom portion UX of the U-shaped portion TU. The cutter unit 6 and the cutter 70 are positioned downstream of the separating member 3F in the conveyance direction and upstream of the roller pair 3A in the conveyance direction.

The sheet feed tray 10 is movable forward through the opening 1B from a state in which the sheet feed tray 10 is attached to the casing 1A. The sheet feed tray 10 includes rollers 51 and 52, a roll sheet accommodating part 11 capable of accommodating a roll sheet R, and a cut sheet accommodating part 12 capable of accommodating a plurality of cut sheets (not illustrated in the drawings) in a state in which the plurality of cut sheets is stacked in the up-down direction. The plurality of cut sheets accommodated in the cut sheet accommodating part 12 is supported on the upper surface of a supporting plate 19 which is disposed along a bottom plate 18 of the sheet feed tray 10. In the sheet feed tray 10, the plurality of cut sheets is removed from the cut sheet accommodating part 12 (see FIG. 2) in a case where the roll sheet R is used, whereas the roll sheet R is removed from the roll sheet accommodating part 11 in a case where the plurality of cut sheets is used.

The sheet S is a general term for a sheet unwound from the roll sheet R and the cut sheet, and is an example of a “recording medium” of the present disclosure. The cut sheet refers to a sheet having a length along the conveyance route T shorter than a length along the conveyance route T of the sheet constructing the roll sheet R.

The roll sheet R is a long sheet S wound in a roll shape around the outer circumferential surface of a cylindrical-shaped core member RC. The roll sheet R is accommodated in the roll sheet accommodating part 11 in a state in which a rotational axis RX (the central axis of the core member RC) of the roll sheet S is aligned along the left-right direction.

Rollers 51 and 52 are disposed at the bottom part of the roll sheet accommodating part 11. The rollers 51 and 52 are driven rollers capable of rotating about a shaft which extends along the left-right direction. In a case where the roll sheet R is accommodated in the roll sheet accommodating part 11, the lower outer circumferential surface of the roll sheet R is supported by the rollers 51 and 52. In a case where the roll sheet R is set, the roll sheet R is manually rotated in a direction of an arrow Q of FIG. 2 so as to unwind the sheet S from the roll sheet R. Then, the sheet S is caused to pass through a gap between the lower surface of the supporting plate 19 and the upper surface of the bottom plate 18 so that the leading edge of the sheet S is held between the roller 13 and a roller 15. In this state, in response to the conveying motor being driven under the control of the controller 100, the roller 13 rotates so as to feed the sheet S, unwound from roll sheet R, rearward.

The roller 13 is supported by one end 14A of the arm 14 and is rotatable about a shaft 13X which extends along the left-right direction. The other end 14B of the arm 14 is supported by the casing 1A via a shaft 14X which extends along the left-right direction. The arm 14 is pivotable on the shaft 14X, with the other end 14B as the fulcrum.

In a case where the cut sheet is not accommodated in the cut sheet accommodating part 12 in the state in which the sheet feed tray 10 is attached to the casing 1A, the roller 13 contacts the roller 15 via a notched portion (not illustrated in the drawings) of the supporting plate 19 (see FIG. 2). In a case where the plurality of cut sheets is accommodated in the cut sheet accommodating part 12 in a state in which the sheet feed tray 10 is attached to the casing 1A, the roller 13 contacts an uppermost cut sheet among the plurality of cut sheets accommodated in the cut sheet accommodating part 12. In this situation, in response to the conveying motor being driven under the control of the controller 100, the roller 13 rotates so as to feed the uppermost cut sheet rearward.

The sheet S (a sheet unwound from the roll sheet R, or a cut sheet) fed from the sheet feed tray 10 by the roller 13 comes into contact with the separating member 3F, moves along the separating member 3F, and is guided toward the roller pair 3A.

The separating member 3F is located behind the roller 13 and extends in an oblique direction crossing both the up-down direction and the front-rear direction. A surface of the separating member 3F has fine irregularities repeating along the conveyance route T. The fine irregularities are configured to reduce occurrence of multiple feed (the phenomenon in which cut sheets are conveyed in a stacked state). That is, the separating member 3F has a function of separating a certain cut sheet in contact with roller 13 from cut sheet(s) other than the certain cut sheet.

The roller pairs 3A, 3B, and 3C are disposed in this order from the upstream of the conveyance direction, and convey the sheet S conveyed by the roller 13 in the conveyance direction. The roller pair 3A is disposed between the cutter unit 6 and the pair of guide members 3G in the conveyance direction. The roller pair 3A guides the sheet S conveyed from roller 13 to the roller pair 3B.

The roller pair 3B feeds the sheet S guided by the roller pair 3A to the head 5. The roller pair 3C discharges the sheet S conveyed by the roller pair 3B to the sheet discharge tray 20. The sheet S conveyed by the roller pairs 3B and 3C is fed forward.

Each of the roller pairs 3A to 3C is constructed of a driving roller which rotates by a driving force transmitted from the conveying motor, and a driven roller which rotates following the driving roller. In response to the conveying motor being driven under the control of the controller 100, the driving rollers and driven rollers of the roller pairs 3A to 3C rotate while nipping the sheet S, thereby conveying the sheet S in the conveyance direction.

The head 5 includes a plurality of nozzles (not illustrated in the drawings) formed on the lower surface of the head 5, and a driver IC (not illustrated in the drawings). The head 5 is an example of a “recording unit” of the present disclosure. In a case where the sheet S conveyed by the conveying mechanism 3 passes through the position facing the lower surface of the head 5, the driver IC is driven under the control of the controller 100, causing ink to be ejected from the plurality of nozzles, and the ink lands on the sheet S, thereby recording an image on the sheet S. Note that the head 5 may be either a head of the line type which ejects the ink from the plurality of nozzles in a state in which the position of the head 5 is fixed, or a head of the serial type which ejects the ink from the plurality of nozzles while moving in the left-right direction.

The cutter unit 6 is configured to cut the sheet S unwound from the roll sheet R, at a location between the separating member 3F and the roller pair 3A in the conveyance route T. The cutter unit 6 includes a cutter 60 and a holder 61 which holds the cutter 60. Further, the cutter unit 6 is detachably attached to a carriage 8 which is supported by the casing 1A.

The carriage 8 is reciprocally movable in the left-right direction by the scanning mechanism 4. The left-right direction is a direction parallel to the sheet S extending along the conveyance route T and crossing a conveyance direction A (see FIG. 2: a conveyance direction in the vicinity of the cutter unit 6). The scanning mechanism 4 is an example of a “moving mechanism” of the present disclosure.

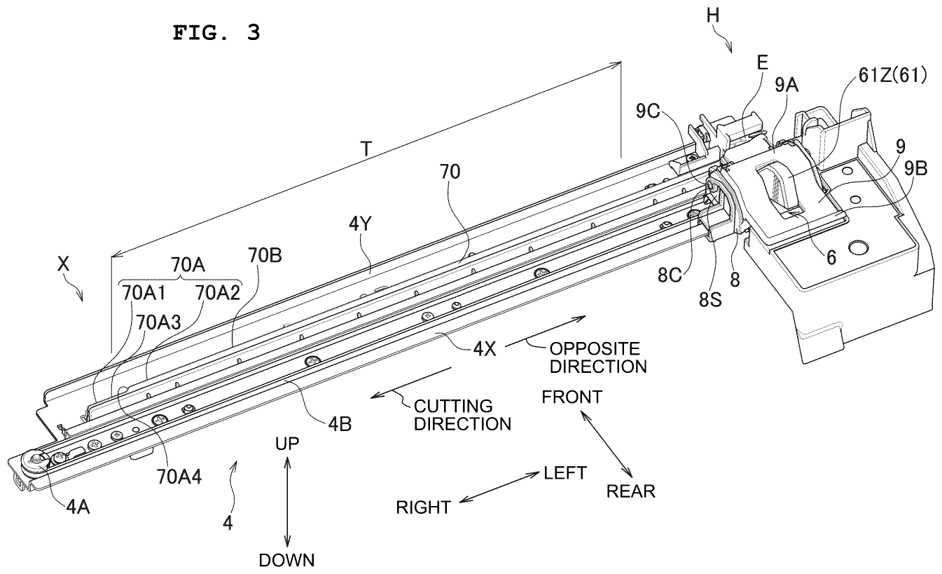

As illustrated in FIG. 3, the scanning mechanism 4 includes a guide rail 4X extending in the left-right direction, a pair of pulleys 4A spaced apart in the left-right direction (only one of the pair of pulleys 4A is illustrated in FIG. 3), a belt 4B which is wound around the pair of pulleys 4A and to which the carriage 8 is fixed, and a cutting motor (not illustrated in the drawings). The pair of pulleys 4A and the belt 4B are attached to the guide rail 4X. The guide rail 4X supports the carriage 8 fixed to the belt 4B and the cutter unit 6 attached to the carriage 8. The guide rail 4X is supported by the casing 1A.

Another guide rail 4Y is disposed in front of the guide rail 4X and at a position facing the guide rail 4X, with the conveyance route T (see FIG. 2) being interposed between the guide rails 4Y and 4X. The guide rail 4Y extends in the left-right direction and is spaced apart from the guide rail 4X in the front-rear direction, with a slight gap. The conveyance route T is defined in this gap.

The guide rail 4Y is supported by the casing 1A. The cutter 70 is attached to the guide rail 4Y. The cutter 70 is a fixed blade fixed to the guide rail 4Y, whereas the cutter 60 is a disc-shaped rotary blade. Further, the cutter 70 is supported by the casing 1A via the guide rail 4Y, whereas the cutter 60 is attachable and detachable with respect to the casing 1A (the carriage 8) together with the holder 61. The cutter 60 and the cutter unit 6 including the cutter 60 are capable of becoming an attached state (see FIG. 3) wherein the cutter 60 and the cuter unit 6 are attached to the casing 1A, and a detached state wherein the cutter 60 and the cutter unit 6 are detached from the attachment position X of the casing 1A.

The cutter 70 is an example of a “first cutter” of the present disclosure, and the cutter 60 is an example of a “second cutter” of the present disclosure. The cutter 60 in the attached state cooperates with the cutter 70 so as to cut the sheet S conveyed by the conveying mechanism 3. In the present embodiment, although the cutters 60 and 70 are both made of a metal material, at least one of the cutter 60 the cutter 70 may be made of a material other than the metal material, such as synthetic resin, as long as the cutters 60 and 70 are capable of cutting the sheet S.

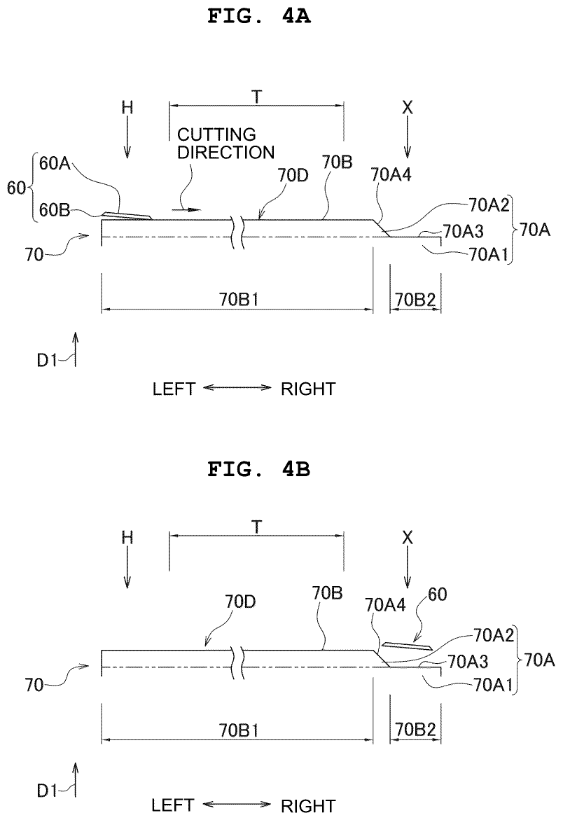

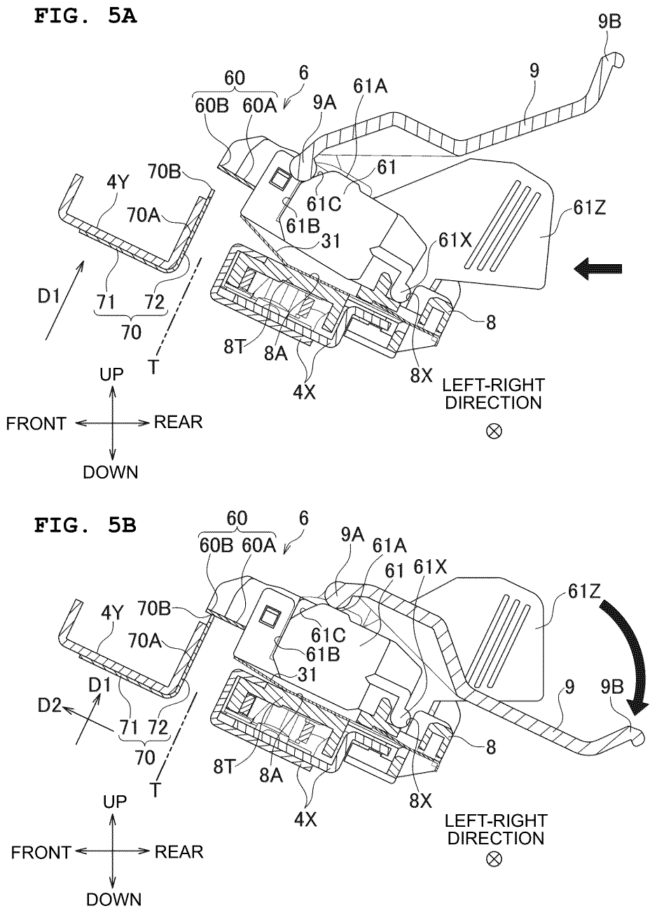

The cutter 70 has an elongated shape extending in the left-right direction, as illustrated in FIG. 3 and FIGS. 4A and 4B. The cutter 70 is L-shaped as illustrated in FIGS. 5A and 5B, and includes a part 71 which covers the lower surface of the guide rail 4Y, and a part 72 which covers the side surface, of the guide rail 4Y, defining the conveyance route T. The part 72 of the cutter 70 extends in a first direction D1 along the conveyance route T and includes a base 70A and a blade 70B disposed at an end of the base 70A. The first direction D1 is a direction crossing the left-right direction and is an example of a “second direction” of the present disclosure.

The base 70A includes a first part 70A1 and a second part 70A2, as illustrated in FIGS. 4A and 4B. Each of the first part 70A1 and the second part 70A2 is a belt-shaped part extending in the left-right direction. The first part 70A1 covers the side surface, of the guide rail 4Y, which defines the conveyance route T. The second part 70A2 is disposed on a part, of the first part 70A1, except for a right end of the first part 70A1. The second part 70A2 constructs a raised part 70D projecting upward beyond an upper surface 70A3 of the first part 70A1.

The blade 70B of the cutter 70 includes a cutting area 70B1 which cooperates with the blade 60B of the cutter 60 to cut the sheet S, and a non-cutting area 70B2 which is disposed side by side with the cutting area 70B1 in the left-right direction. The cutting area 70B1 is an area in which the blade 70B is disposed at an upper end of the second part 70A2 and which extends in the left-right direction. Further, the cutting area 70B1 is longer than the conveyance route T in the left-right direction. The conveyance route T is present within the cutting area 70B1 in the left-right direction.

The non-cutting area 70B2 is an area located downstream in the cutting direction of the cutting area 70B1, that is an area in which the blade 70B is disposed at an upper end of a right end of the first part 70A1, i.e., the non-cutting area 70B2 is located downstream of the cutting area 70B1 in the cutting direction. Further, the non-cutting area 70B2 is located below the cutting area 70B1 in the first direction D1. In other words, the non-cutting area 70B2 is located farther away from the cutter 60 than the cutting area 70B1 is in the first direction D1, in a case where the cutter unit 6 is in the attached state at the attachment position X, as illustrated in FIG. 4B.

Furthermore, the second part 70A2 has an inclined surface 70A4 at a right end, of the second part 70A2, which is a boundary part between the cutting area 70B1 and the non-cutting area 70B2. The inclined surface 70A4 is inclined further downward as the inclined surface 70A4 extends rightward (a cutting direction to be described later), and a right end of the inclined surface 70A4 connects to the upper surface 70A3 of the first part 70A1.

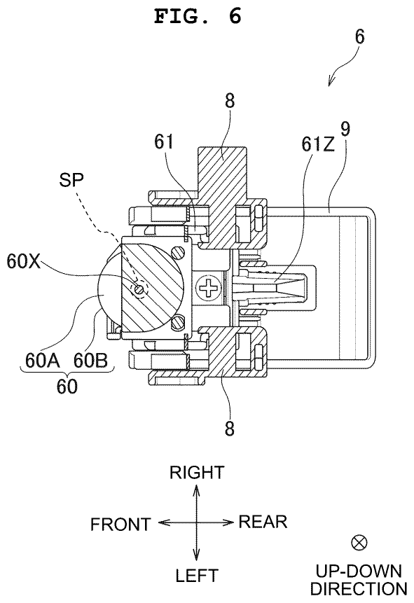

As illustrated in FIG. 6, the cutter 60 has a disk-shaped base 60A and a blade 60B disposed at a circumferential edge of the base 60A, and is supported by a holder 61 to be rotatable about the shaft 60X. In a case where the cutter 60 is in the attached state, the cutter 60 extends in a second direction D2 crossing the first direction D1, and is disposed so that the blade 60B is close to the blade 70B, as illustrated in FIG. 5B.

In response to the cutting motor (the scanning mechanism 4) being driven under the control of the controller 100, the belt 4B travels in the left-right direction, and the carriage 8 and the cutter unit 6 attached to the carriage 8 are moved from a home position H outside the conveyance route T to the inside of the conveyance route T (see FIG. 3). In this situation, the cutter 60 rotates based on the driving of the cutting motor. The sheet S unwound from the roll sheet R is cut in the width direction of the sheet S by the cutter 70 which is fixed and the cutter 60 which rotates while moving in the left-right direction.

The attachment position X is located at the right ends of the guide rails 4X and 4Y, as illustrated in FIG. 3, and serves as a position at which the cutter unit 6 is attached to or detached from the carriage 8. The home position H is located at the left ends of the guide rails 4X and 4Y and serves as a start position for moving the cutter 60 in a case where the sheet S is cut. In other words, in a case where the sheet S is cut, the cutter 60 moves rightward, namely, in the cutting direction, from the home position H. In a case where the cutting of the sheet S is completed, the cutter 60 moves leftward (namely, in a direction opposite to the cutting direction) and returns to the home position H.

A sensor E electrically connected to the controller 100 is disposed at the home position H. The sensor E outputs an ON signal to the controller 100 in a case where the cuter unit 6 is located at the home position H based on the contact between the cutter unit 6 and the sensor E, and outputs an OFF signal to the controller 100 in a case where the cutter unit 6 is not located at the home position H based on separation of the sensor E from the cutter unit 6. In a case where the recording is performed by using the roll sheet R and where the controller 100 receives the ON signal from the sensor E, the controller 100 controls the conveying motor, the driver IC, and the cutting motor to perform a recording process of recording an image on the sheet S.

The opening 1C (see FIG. 2) extends through the rear wall of the casing 1A. A part, of the casing 1A, including the attachment position X (the carriage 8 located at the attachment position X) is exposed to the outside of the casing 1A via the opening 1C. The opening 1C extends through a part, of the casing 1A, which faces the bottom portion UX of the U-shaped portion TU described above.

A cover 21 configured to cover the opening 1C is attached to the rear wall of the casing 1A. The cover 21 is pivotable on a shaft 21X extending along the left-right direction and disposed at a lower end of the opening 1C. The cover 21 pivots on the shaft 21X so that the cover 21 is selectively switchable between a closed position (see solid lines in FIG. 2) at which the opening 1C is closed by the cover 21, and an open position (see broken lines in FIG. 2) at which the opening 1C is open.

A cover sensor CS electrically connected to the controller 100 is disposed in the casing 1A. The cover sensor CS outputs an ON signal to the controller 100 in a case where the cover 21 is at the open position, and outputs an OFF signal to the controller 100 in a case where the cover 21 is located at the closed position. The controller 100, upon receiving the ON signal from the cover sensor CS, controls the cutting motor so that the carriage 8 and the cutter unit 6 attached to the carriage 8 move from the home position H to the attachment position X. As a result, by locating the cover 21 at the open position (see the broken lines in FIG. 2), the cutter unit 6 can be attached to or detached from the carriage 8 at the attachment position X via the opening 1C. Further, the controller 100, upon receiving the OFF signal from the cover sensor CS, controls the cutting motor so that the carriage 8 and the cutter unit 6 attached to the carriage 8 move from the attachment position X to the home position H.

The carriage 8 includes a bottom wall 8T (see FIGS. 5A and 5B) and a pair of side walls 8S spaced apart from each other in the left-right direction (only one of the pair of side walls 8S is illustrated in FIG. 3). The cutter unit 6 is disposed between the pair of side walls 8S and supported on a supporting surface 8A (see FIGS. 5A and 5B) which is the upper surface of the bottom wall 8T. A plate spring 31 is attached to the supporting surface 8A. The cutter unit 6 is supported by the supporting surface 8A in a state in which an upward urging force is applied to the cutter unit 6 by the plate spring 31.

As illustrated in FIG. 3, a lever 9 is attached to the carriage 8. The lever 9 has a shaft 9C extending along the left-right direction and is pivotable relative to the carriage 8 on the shaft 9C as the pivot center. The shaft 9C is inserted into holes 8C extending through the side walls 8S of the carriage 8.

By pivoting on the shaft 9C, the lever 9 is selectively switchable between a release position (see FIG. 5A) at which the lever 9 releases the fixing of the cutter unit 6 with respect to the carriage 8, and a fixing position (see FIG. 5B) at which the lever 9 fixes the cutter unit 6 with respect to the carriage 8.

In a case where the user attaches the cutter unit 6 to the carriage 8 located at the attachment position X, the user moves the cutter unit 6 forward while holding a handle 61Z disposed at the rear end of the holder 61 in a state in which the lever 9 is located at the release position (see FIG. 5A), thereby inserting the cutter unit 6 into a space between the pair of side walls 8S (see FIG. 3) of the carriage 8. With this, the cutter unit 6 is temporarily positioned with respect to the carriage 8 in the left-right direction, by the pair of side walls 8S. In this situation, a projecting part 61X disposed at the rear end of the holder 61 is located inside a recessed part 8X of the carriage 8. Further, the front end part of the cutter unit 6 is lifted upward by the urging force of the plate spring 31, causing the blades 60B and 70B to be separated from each other. In this situation, the front end 9A of the lever 9 is in contact with the inclined surface 61C defined at the boundary between an upper surface 61A and a front surface 61B of the holder 61.

Afterward, the user presses a rear end 9B of the lever 9 downward to thereby move the lever 9 from the release position (see FIG. 5A) to the fixing position (see FIG. 5B). In this situation, the front end 9A of lever 9 moves along the inclined surface 61C of the holder 61 and reaches the upper surface 61A of the holder 61. As a result, the front end 9A of the lever 9 presses against the upper surface 61A of holder 61, and presses the cutter unit 6 toward the supporting surface 8A, resisting the urging force of the plate spring 31. With this, the cutter unit 6 is fixed to the carriage 8, bringing the cutter unit 6 into the attached state. In this situation, the spacing in the first direction D1 between the blades 60B and 70B is smaller than the spacing between the blades 60B and 70B in a case where the lever 9 is located at the release position (see FIG. 5A), and realizing a predetermined spacing suitable for cutting the sheet S.

Next, the positional relationship between the cutter 60 and the cutter 70 will be described. In the present embodiment, as illustrated in FIG. 4B, in a process where the cutter unit 6 transitions from the detached state to the attached state at the attachment position X of the casing 1A, the blade 60B of the cutter 60 faces the non-cutting area 70B2 in the first direction D1. In other words, the cutter 60 becomes a non-contact state, in which the cutter 60 is separated from the blade 70B, so that the blade 60B does not contact the blade 70B of the cutter 70 in the first direction D1. Then, in a case where the cutter unit 6 is located at a position other than the attachment position X in a process where the carriage 8 and the cutter unit 6 attached to the carriage 8 move from the attachment position X to the home position H, or from the home position H to the attachment position X, the cutter 60 becomes a contact state in which the blade 60B of the cutter 60 contacts the blade 70B of the cutter 70. The position of the carriage 8 at which the blade 60B of the cutter 60 attached to the carriage 8 is in contact with the blade 70B of the cutter 70 is an example of a “contact position”. The position of the carriage 8 at which the blade 60B of the cutter 60 attached to the carriage 8 is separated from the blade 70B of the cutter 70 is an example of a “non-contact position”.

As illustrated in FIGS. 4A and 4B, the cutter 60 in the attached state is attached to the holder 61 in a posture wherein the cutter 60 is not parallel to the left-right direction, but is inclined in a direction obliquely downward to the right. In other words, as illustrated in FIG. 4A, the cutter 60 in the contact state is inclined relative to the cutter 70 such that the left end of the cutter 60 is located farther away from the cutter 70 along the first direction D1 than the right end of the cutter 60 is. Further, in the contact state realized in a process where the cutter unit 6 moves in the cutting direction from the home position H to the attachment position X, the blades 60B and 70B contact with each other so that the blades 60B and 70B are capable of cutting the sheet S. The left end of the cutter 60 is an example of a “first end” of the present disclosure, and the right end of the cutter 60 is an example of a “second end” of the present disclosure.

In a case where the user detaches the cutter unit 6 from the carriage 8 located at the attachment position X, the user lifts the rear end 9B of the lever 9 to move the lever 9 from the fixing position (see FIG. 5B) to the release position (see FIG. 5A). In this situation, the front end 9A of the lever 9 moves from the upper surface 61A to the inclined surface 61C of the holder 61. As a result, the pressing exerted by the front end 9A of the lever 9 is released, thereby causing the front end of the cutter unit 6 to move upward by the urging force of the plate spring 31, in a state in which the projecting part 61X is located inside the recessed part 8X. In this situation, the spacing in the first direction D1 between the blades 60B and 70B becomes greater than the spacing in the first direction D1 between the blades 60B and 70B in a case where the lever 9 is located at the fixing position (see FIG. 5B).

Afterward, in a state in which the lever 9 is located at the release position (see FIG. 5A), the user moves the cutter unit 6 rearward so as to pull the cutter unit 6 out from the space between the pair of side walls 8S of the carriage 8, while holding the handle 61Z disposed at the rear end of the holder 61. As a result, the cutter unit 6 is detached from the carriage 8 and becomes the detached state.

As described above, according to the printer 1 of the present embodiment, the cutter 60 becomes the non-contact state, in a case where the cutter 60 transitions from the detached state to the attached state. As a result, in a case where the cutter 60 transitions from the detached state to the attached state, the blade 60B of the cutter 60 does not come into contact with the cutter 70, and thus occurrence of damaging of the blade 60B of the cutter 60 can be reduced.

The blade 70B of the cutter 70 includes the cutting area 70B1 disposed at the upper end of the second part 70A2 which constructs the raised part 70D, and the non-cutting area 70B2 disposed at the upper end of the right end of the first part 70A1. In a case where the cutter 60 transitions from the detached state to the attached state, the blade 60B of the cutter 60 faces the non-cutting area 70B2 in the first direction D1. This simple configuration wherein a difference in level is disposed in the cutter 70 reduces occurrence of damaging of the blade 60B of the cutter 60.

In the configuration where the cutter 60 is inclined as described above, in a case where the non-cutting area 70B2 is located upstream of the cutting area 70B1 in the rightward direction (the cutting direction), and where the cutter 60 moves in the cutting direction, the blade 60B of the cutter 60 might come into contact with the boundary part (the left side surface of the raised part 70D) between the cutting area 70B1 and the non-cutting area 70B2, which might damage the blade 60B. In contrast, in the configuration of the present embodiment, the non-cutting area 70B2 is located downstream in the rightward direction (the cutting direction) of the cutting area 70B1. Accordingly, in a case where the cutter 60 moves in the cutting direction, the blade 60B of the cutter 60 does not come into contact with the right side surface of the raised part 70D. With this, occurrence of damaging of the blade 60B of the cutter 60 can be reduced.

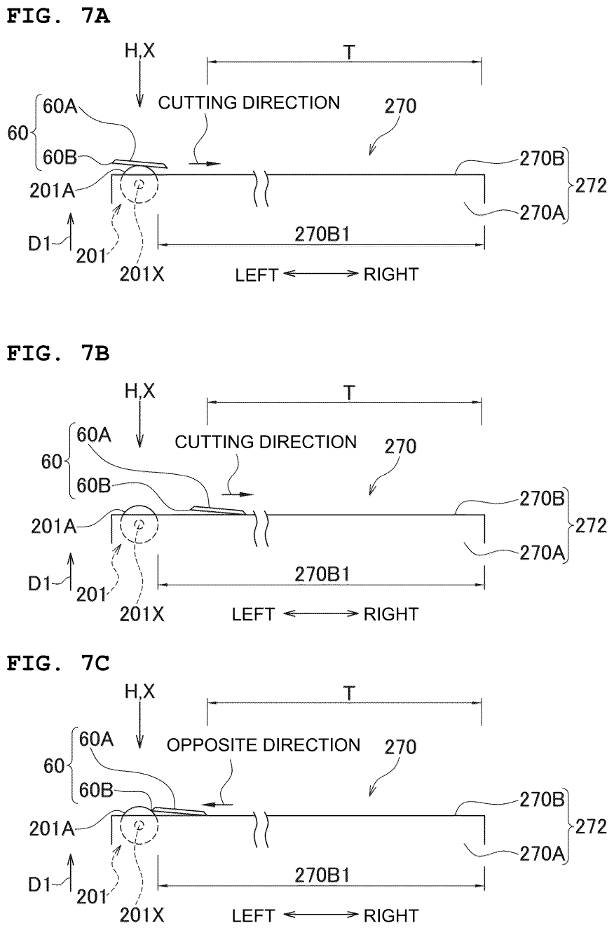

Next, a printer 1 according to the second embodiment of the present disclosure will be described, with reference to FIGS. 7A to 7C. The printer 1 in the second embodiment further includes a roller 201. In the printer 1, the attachment position X and the home position H are located at the left ends of the guide rails 4X and 4Y, and the configuration of the cutter 270 is slightly different from the configuration of the cutter 70 according to the first embodiment. Note that the configurations according to the second embodiment which are similar to the configurations according to the first embodiment are designated by the same reference numerals as the reference numerals of the first embodiment, and any detailed description will be omitted. The cutter 270 is an example of the “first cutter” of the present disclosure.

The cutter 270 has a similar configuration to the configuration of the above-described cutter 70, except for having a part 272 extending uniformly in the left-right direction, rather than having the part 72 of the first embodiment. The part 272 extends in the first direction D1 along the conveyance route T and includes a base 270A and a blade 270B disposed at an end of the base 270A. Further, the blade 270B of the cutter 270 has a cutting area 270B1 which cooperates with the blade 60B of the cutter 60 to cut the sheet S. The cutting area 270B1 extends rightward from the right end of an area, of the blade 270B, facing the roller 201.

The roller 201 is disposed between the guide rails 4X and 4Y and supported by the guide rail 4X at a position in front of the guide rail 4X. In other words, the roller 201 is supported by the casing 1A via the guide rail 4X. Note that the roller 201 may be supported by the casing 1A via a member other than the guide rail 4X.

The roller 201 is disposed at the left end of the guide rail 4X, as illustrated in FIG. 7A. The roller 201 is supported rotatably about an axis 201X which extends while crossing both the left-right direction and the first direction D1. The axis 201X is an example of a “rotation axis” of the present disclosure.

The roller 201 is disposed such that the upper part of the roller 201 projects upward beyond the blade 270B of the cutter 270. More specifically, the upper end of the roller 201 is disposed above the left end of the cutter 60 in the contact state, as illustrated in FIG. 7C. The contact state refers to such a state that is brought about in a case where the cutter unit 6 is located at a position other than the attachment position X, for example, when the carriage 8 and the cutter unit 6 attached to the carriage 8 move from the attachment position X (the home position H) to the right ends of the guide rails 4X and 4Y, or when the carriage 8 and the cutter unit 6 attached to the carriage 8 move from the right ends of the guide rails 4X and 4Y to the attachment position X (the home position H), and refers to a state that the blade 60B of the cutter 60 is in contact with the blade 270B of the cutter 270.

The cutter 60 is disposed to be movable upward and downward in the axial direction of the shaft 60X. Further, the cutter 60 is urged downward in the axial direction by a spring SP. The spring SP may be a coil spring disposed above the cutter 60 and around the shaft 60X.

With this configuration, in a case where the cutter unit 6 transitions from the detached state to the attached state at the attachment position X of the casing 1A, the base 60A of the cutter 60 comes into contact with the circumferential surface 201A of the roller 201, as illustrated in FIG. 7A. In other words, the circumferential surface 201A of the roller 201 comes into contact with the base 60A, of the cutter 60, which is other than the blade 60B. As a result, the cutter 60 becomes the non-contacting state in which the blade 60B is located away from the blade 270B of the cutter 270 in the first direction D1. The circumferential surface 201A is an example of a “contact part” of the present disclosure.

In a case where a sheet S unwound from the roll sheet R is cut, the controller 100 controls the cutting motor so that the carriage 8 and the cutter unit 6 attached to the carriage 8 move rightward, namely, in the cutting direction, from the home position H (i.e., the attachment position X), as illustrated in FIG. 7B. In this situation, since the cutter 60 is urged downward by the spring SP, as the cutter 60 moves in the cutting direction from the home position H, a part of the blade 60B at the right end of the cutter 60 approaches closer to and comes into contact with the blade 270B of the cutter 270, and the cutter 60 becomes the contact state.

In a case where the cutting of the sheet S unwound from the roll sheet R is completed, the controller 100 controls the cutting motor so that the carriage 8 and the cutter unit 6 attached to the carriage 8 move leftward, namely, in the direction opposite to the cutting direction, as illustrated in FIG. 7C. In this situation, immediately before the cutter 60 returns to the home position H, the left end of the cutter 60 comes into contact with the circumferential surface 201A of the roller 201. As the cutter 60 moves leftward while being in contact with the roller 201, the roller 201 rotates counterclockwise in FIG. 7A to FIG. 7C, lifting the cutter 60 upward. Thus, the cutter 60 becomes the non-contact state in which the blade 60B is away from the blade 270B. Further, the roller 201 rotates in response to the cutter 60 being moved toward the home position H (i.e., the attachment position X), thereby reducing occurrence of biting of the blade 60B of the cutter 60 into the circumferential surface 201A of the roller 201. With this, occurrence of damaging of the blade 60B of the cutter 60 can be reduced.

In the second embodiment, in a case where the cutter 60 transitions from the detached state to the attached state, the part, of the cutter 60, which is other than the blade 60B comes into contact with the circumferential surface 201A of the roller 201, and the cutter 60 becomes the non-contact state. As a result, the blade 60B of the cutter 60 does not come into contact with the cutter 270, thereby reducing occurrence of damaging of the blade 60B of the cutter 60. Further, in a case where the cutter 60 transitions from the detached state to the attached state, the cutter 60 comes into contact with the circumferential surface 201A. Thus, the posture of the cutter 60 is maintained. As a result, the cutter 60 is less likely to approach the cutter 270, and thus, occurrence of contact between the blade 60B of the cutter 60 and the cutter 270 can be reduced effectively.

Furthermore, the contact part which comes into contact with the cutter 60 in a case where the cutter 60 transitions from the detached state to the attached state is the circumferential surface of the roller 201. With this, as the roller 201 rotates, the cutter 60 can be smoothly moved along the left-right direction from the attachment position X.

Moreover, the scanning mechanism 4 moves the cutter 60 in the cutting direction from the home position H (i.e., the attachment position X) in a case where the sheet S is cut. In the printer 1 of the first embodiment, the home position H and the attachment position X are located, respectively, at the different ends of the guide rails 4X and 4Y. Therefore, a space for positioning the carriage 8 is required for each of the home position H and the attachment position X, resulting in a printer 1 which is long in the left-right direction. In contrast, in the second embodiment, the attachment position X and the home position H are at the same position. Therefore, the length of the printer 1 in the left-right direction can be reduced.

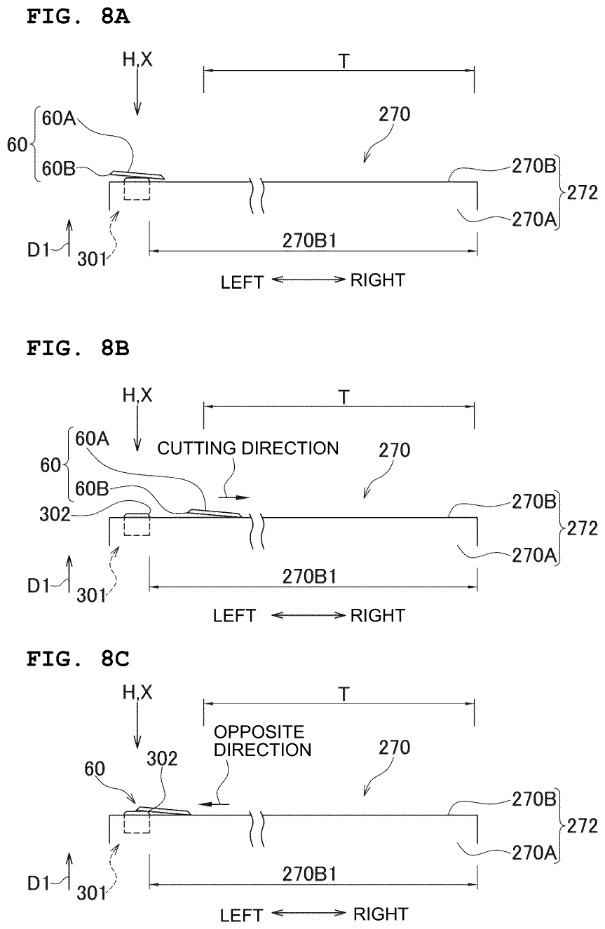

Next, a printer 1 according to a third embodiment of the present disclosure will be described, with reference to FIGS. 8A to 8C. The printer 1 according to the third embodiment is substantially the same as the printer 1 according to the second embodiment, except that the printer 1 according to the third embodiment includes a chute member 301, rather than the above-described roller 201. Note that the configurations according to the third embodiment which are similar to the configurations according to the first and second embodiments are designated by the same reference numerals as the reference numerals of the first and second embodiments, and any detailed description will be omitted. The chute member 301 is an example of the “contact part” of the present disclosure.

The blade 270B of the cutter 270 has a cutting area 270B1 which cooperates with the blade 60B of the cutter 60 to cut the sheet S. The cutting area 270B1 extends rightward from the right end of an area, of the blade 270B, which faces the chute member 301.

The chute member 301 is disposed between the guide rails 4X and 4Y and supported by the guide rail 4X at a position in front of the guide rail 4X. In other words, the chute member 301 is supported by the casing 1A via the guide rail 4X. Note that the chute member 301 may be supported by the casing 1A via a member other than the guide rail 4X.

The chute member 301 is disposed at the left end of the guide rail 4X, as illustrated in FIG. 8A. The chute member 301 extends in the first direction D1 and the left-right direction. Further, in the first direction D1, an upper part of the chute member 301 is positioned to project upward beyond the blade 270B so that the chute member 301 projects toward the cutter 60 than the cutter 270. More specifically, the upper end of the chute member 301 is located below the left end of the cutter 60 which faces the cutting area 270B1 and the upper end of the chute member 301 is disposed more closely to the cutter 270 than the left end of the cutter 60 which faces the cutting area 270B1, as illustrated in FIG. 8C. With this, in a case where the cutter 60 is being moved leftward, namely, in the direction opposite to the cutting direction, and is being moved to the attachment position X, the cutter 60 can be caused to ride onto the chute member 301.

A curved part 302 is disposed at a corner part at the right end of the upper part of the chute member 301. With this, in case where the cutter 60 is moved leftward to the attachment position X, the cutter 60 can be smoothly ridden onto the chute member 301.

Owing to such a configuration, in a case where the cutter unit 6 transitions from the detached state to the attached state at the attachment position X of the casing 1A, as illustrated in FIG. 8A, the base 60A of the cutter 60 comes into contact with the upper end of the chute member 301. In other words, the upper end of the chute member 301 contacts the base 60A, of the cutter 60, which is other than the blade 60B. As a result, the cutter 60 becomes a non-contact state in which the blade 60B is away from the blade 270B of the cutter 270 in the first direction D1.

In a case where the sheet S unwound from the roll sheet R is cut, the controller 100 controls the cutting motor so that the carriage 8 and the cutter unit 6 attached to the carriage 8 move rightward, namely, in the cutting direction, from the home position H (i.e., the attachment position X) as illustrated in FIG. 8B. In this situation, since the cutter 60 is urged downward by the spring SP, as the cutter 60 moves in the cutting direction from the home position H, the part of the blade 60B at the right end of cutter 60 approaches to and comes into contact with the blade 270B of cutter 270, and the cutter 60 becomes the contact state.

In a case where the cutting of the sheet S unwound from the roll sheet R is completed, the controller 100 controls the cutting motor so that the carriage 8 and the cutter unit 6 attached to the carriage 8 move leftward, namely, in the direction opposite to the cutting direction, as illustrated in FIG. 8C. In this situation, immediacy before the cutter 60 returns to the home position H, the bottom surface of the cutter 60 comes into contact with the curved part 302 of the chute member 301. As the cutter 60 moves leftward while the cutter 60 is in contact with the curved part 302, the cutter 60 is lifted upward by the chute member 301. Thus, the cutter 60 becomes the non-contact state.

In the third embodiment, in a case where the cutter 60 transitions from the detached state to the attached state, the part, of the cutter 60, which is other than the blade 60B comes into contact with the upper end of the chute member 301 and becomes the non-contact state. As a result, the blade 60B of the cutter 60 does not come into contact with the cutter 270, and thus occurrence of damaging of the blade 60B of the cutter 60 can be reduced. Further, in a case where the cutter 60 transitions from the detached state to the attached state, the cutter 60 comes into contact with the upper end of the chute member 301, and thus the posture of the cutter 60 can be maintained. As a result, the cutter 60 is less likely to approach the cutter 270, and thus occurrence of contact between the blade 60B of the cutter 60 and the cutter 270 can be reduced effectively.

The upper part of chute member 301 projects upward beyond the cutter 270. With this, in a case where the cutter 60 transitions from the detached state to the attached state, occurrence of contact between the blade 60B of the cutter 60 and the cutter 270 can be reduced effectively.

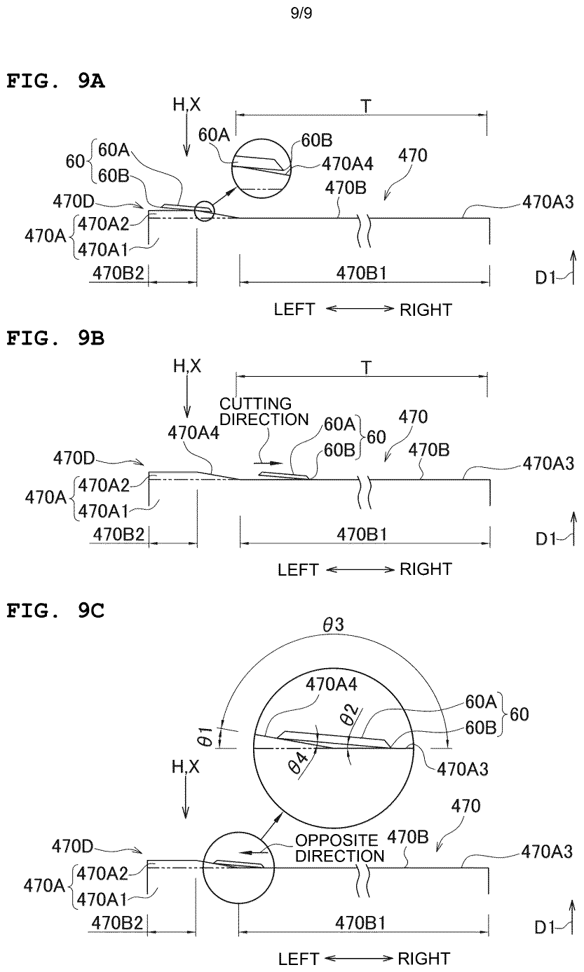

Next, a printer 1 according to a fourth embodiment of the present disclosure will be described in detail, with reference to FIGS. 9A to 9C. In the printer 1 according to the fourth embodiment, the attachment position X and the home position H are located at the left ends of the guide rails 4X and 4Y, and the configuration of a cutter 470 is different from the configuration of the cutter 70 according to the first embodiment. Note that the configurations according to the fourth embodiment which are similar to the configurations according to the first embodiment are designated by the same reference numerals as the reference numerals of the first embodiment, and any detailed description will be omitted. The cutter 470 is an example of the “first cutter” of the present disclosure.

The cutter 470 has an elongated shape extending in the left-right direction. A base 470A of the cutter 470 includes a first part 470A1 and a second part 470A2. Each of the first part 470A1 and the second part 470A2 is a belt-shaped part extending in the left-right direction. The first part 470A1 covers the side surface, of the guide rail 4Y, which defines the conveyance route T. The second part 470A2 is disposed on a left end of the first part 470A1 and constructs a raised part 470D projecting upward beyond an upper surface 470A3 of the first part 70A1.

The blade 470B of the cutter 470 includes a cutting area 470B1 which cooperates with the blade 60B of the cutter 60 to cut the sheet S, and a non-cutting area 470B2 which is disposed side by side with the cutting area 470B1 in the left-right direction. The cutting area 470B1 is an area in which the blade 470B is disposed in an upper end, of the first part 470A, other than the left end of the first part 470A1, and extends in the left-right direction.

The non-cutting area 470B2 is located in an area in which the blade 470B is disposed at an upper end of the second part 470A2, i.e., the non-cutting area 470B2 is located upstream in the cutting direction of the cutting area 470B1. Further, the non-cutting area 470B2 is located above the cutting area 470B1 in the first direction D1. In other words, as illustrated in FIG. 9A, the cutting area 470B1 is located farther away from the cutter 60 at a non-contact state (described below) than the non-cutting area 470B2 is, in the first direction D1. A difference in level generated by the raised part 470D defines the boundary between the cutting area 470B1 and the non-cutting area 470B2.

In the above-described configuration, in a case where the cutter unit 6 transitions from the detached state to the attached state at the attachment position X of the casing 1A, the base 60A of the cutter 60 comes into contact with a corner part at the right end of the raised part 470D, as illustrated in FIG. 9A. In other words, the corner part at the right end of the raised part 470D comes into contact with the base 60A, of the cutter 60, which is other than the blade 60B. As a result, the cutter 60 becomes the non-contact state in which the blade 60B is away from the cutter 470 (the blade 470B) in the first direction D1. The raised part 470D is an example of the “contact part” of the present disclosure. This simple configuration wherein a difference in level is disposed in the cutter 470 realizes the contact part.

In a case where the sheet S unwound from the roll sheet R is cut, the controller 100 controls the cutting motor so that the carriage 8 and the cutter unit 6 attached to the carriage 8 move rightward, namely, in the cutting direction, from the home position H (i.e., the attachment position X) as illustrated in FIG. 9B. In this situation, since the cutter 60 is urged downward by the spring SP, as the cutter 60 moves from the home position H in the cutting direction, the part of the blade 60B at the right end of the cutter 60 approaches to and comes into contact with the blade 470B of the cutter 470, and the cutter 60 becomes the contact state.

Further, a right end part, of the second part 470A2, which is a downstream end in the cutting direction of the second part 470A2 has an inclined surface 470A4 at the boundary part between the cutting area 470B1 and the non-cutting area 470B2. The inclined surface 470A4 is inclined further downward as the inclined surface 470A4 extends in the cutting direction, and a right end of the inclined surface 470A4 connects to an upper surface 470A3 of the first part 470A1.

An upstream end in the cutting direction of the inclined surface 470A4 is farther away from the cutting area 470B1 in the first direction than the left end of the cutter 60 is, in a case where the cutter 60 is in the contact state where the blade part 60B of the cutter unit 60 is in contact with the blade part 470B of the first part 470A1 in the upper surface 470A3 of the first part 470A1, as illustrated in FIG. 9B. In other words, the upstream end in the cutting direction of the inclined surface 470A4 is located above the left end of the cutter 60. The contact state refers to a state that is brought about in a case where the cutter unit 6 is located at a position other than the attachment position X, for example, when the carriage 8 and the cutter unit 6 attached to the carriage 8 move from the attachment position X (the home position H) toward the right ends of the guide rails 4X and 4Y, or when the cutter unit 6 move from the right ends of the guide rails 4X and 4Y toward the attachment position X (the home position H), and refers to a state that the blade 60B of the cutter 60 is in contact with the blade 470B of the cutter 470.

An inclination angle θ1, which is the angle defined by the inclined surface 470A4 with respect to the left-right direction, is greater than an acute angle θ2 defined between the cutter 60 and the cutting area 470B1 of the cutter 470 in a case where the cutter 60 is in the contact state, as illustrated in FIG. 9C, and is equal to or less than twice the angle θ2. The inclination angle θ1 is an angle obtained by subtracting, from 180°, an obtuse angle θ3 defined between the inclined surface 470A4 and the cutting area 470B1 (the upper surface 470A3) of the cutter 470.

In a case where the cutting of the sheet S unwound from the roll sheet R is completed, the controller 100 controls the cutting motor so that the carriage 8 and the cutter unit 6 attached to the carriage 8 move leftward, namely, in the direction opposite to the cutting direction, as illustrated in FIG. 9C. In this situation, immediately before the cutter 60 returns to the home position H, the left end of the cutter 60 comes into contact with the inclined surface 470A4. As the cutter 60 moves leftward, the cutter 60 moves upward along the inclined surface 470A4. In a case where the cutter 60 returns to the home position H at which the base 60A contacts the corner part at the right end of the raised part 470D, the cutter 60 is in the non-contact state.

In a case where the cutter 60 is moved along the inclined surface 470A4 to the home position H (i.e., the attachment position X), an acute angle θ4 defined between the inclined surface 470A4 and the cutter 60 is equal to or less than the angle θ2. In other words, the angle θ4 defined between the left end of the cutter 60 and the inclined surface 470A4 in the case where the cutter 60 moves in the opposite direction from the cutting area 470B1 to the non-cutting area 470B2 is equal to or less than the angle θ2 defined between the right end of the cutter 60 and the cutting area 470B1 in the case where the cutter 60 moves in the cutting direction from the non-cutting area 470B2 to the cutting area 470B1. Therefore, even in a case where a part of the blade part 60B at the left end of the cutter 60 comes into contact with the inclined surface 470A4 as the cutter 60 moves in the opposite direction, the blade 60B is less likely to be damaged.

In the fourth embodiment, in a case where the cutter 60 transitions from the detached state to the attached state, the part, of the cutter 60, which is other than the blade 60B comes into contact with the corner part at the right end of the raised part 470D and becomes the non-contact state. As a result, the blade 60B of the cutter 60 does not come into contact with the cutter 470, and thus occurrence of damaging of the blade 60B of the cutter 60 can be reduced. Further, in a case where the cutter 60 transitions from the detached state to the attached state, the cutter 60 comes into contact with the corner part at the right end of the raised part 470D, and thus the posture of the cutter 60 can be maintained. As a result, the cutter 60 is less likely to approach the cutter 470, and thus contact between the blade 60B of the cutter 60 and the cutter 470 can be reduced effectively.

The blade 470B of the cutter 470 includes the non-cutting area 470B2 disposed at the upper end of the second part 470A2 which constructs the raised part 470D, and the cutting area 470B1 disposed at the upper end, of the first part 470A1, which is other than the left end of the first part 470A1. In a case where the cutter 60 transitions from the detached state to the attached state, the blade 60B of the cutter 60 faces the non-cutting area 70B2 in the first direction D1. This simple configuration wherein a difference in level is disposed in the cutter 70 reduces occurrence of damaging of the blade 60B of the cutter 60.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the first embodiment, the part, of the first part 70A1, that positions in the non-cutting area 70B2 may be omitted. In other words, the cutter 70 may not have the part that is located in the attachment position X. Even in such a configuration, the cutter unit 6 can be attached to the carriage 8 positioned at the attachment position X without causing contact between the blade 60B of the cutter 60 and the blade 70B of the cutter 70.

In each of the above-described embodiments, the cutter 60 included in the cutter unit 6 has the circular disc shape and rotates. The cutter 60, however, is not limited to this configuration, and may be fixed to the cutter unit 6. Further, the cutter unit 6 may cut a cut sheet.

The inclined surface 70A4, 470A4 may extend in the direction orthogonal to the left-right direction (the first direction D1) in a case where the upper end in the first direction D1 of the inclined surface 70A4, 470A4 is closer to the cutter 70, 470 than the left end of the cutter 60 is. Further, the inclination angle θ1 may be greater than twice the angle θ2.

The recording medium is not limited to the paper sheet and may be fabric or plastic film. That is, the recording medium may be made of any material. Further, the recording medium is not limited to the medium having the sheet form.

The head 5 as the recording unit may eject a liquid other than the ink (for example, a treatment liquid which agglutinates or precipitates a component of ink, etc.). Further, the recording unit is not limited to the liquid ejecting system, and may be of the laser system, the thermal transfer system, etc.

The present disclosure is not limited to the printer, and is applicable also to a facsimile, a copy machine, a multi-function peripheral, etc.

What is claimed is

1. A recording apparatus comprising:
a conveying unit;
a recording unit;
a first cutter;
a second cutter; and
a casing, wherein:
the recording apparatus is configured to convey a recording medium by the conveying unit, record an image on the conveyed recording medium by the recording unit, and cut the conveyed recording medium by the first cutter and the second cutter;
the first cutter is supported by the casing;
the second cutter is attachable and detachable with respect to a carriage supported by the casing;
the carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position; and
the second cutter is attachable to the carriage positioned at the non-contact position.

2. The recording apparatus according to claim 1, wherein:
the blade of the first cutter extends along a first direction, and has a cutting area configured to cooperate with the blade of the second cutter to cut the recording medium and a non-cutting area disposed side by side with the cutting area in the first direction;
the non-cutting area is located farther away from the second cutter attached to the carriage in a second direction crossing the first direction than the cutting area is; and
in a case where the carriage is positioned at the non-contact position, the blade of the second cutter attached to the carriage faces the non-cutting area in the second direction.

3. The recording apparatus according to claim 2, wherein:
the second cutter attached to the carriage is inclined with respect to the first cutter so that a first end in the first direction of the second cutter is farther away from the first cutter in the second direction than a second end in the first direction of the second cutter is, at the contact position;
in a case where the recording medium is cut, the carriage is configured to move the second cutter in a cutting direction being a direction from the first end toward the second end in the first direction of the second cutter; and
the non-contact position is located downstream of the contact position in the cutting direction.

4. The recording apparatus according to claim 1, further comprising a contact part configured to contact a part, of the second cutter attached to the carriage, other than the blade, in a case where the carriage is positioned at the non-contact position.

5. The recording apparatus according to claim 4, wherein:
the blade of the first cutter extends along a first direction; and
the contact part is a circumferential surface of a roller supported by the casing in a state that the roller is rotatable about a rotation axis crossing the first direction.

6. The recording apparatus according to claim 5, wherein:
the second cutter is a disc-shaped rotary blade;
the second cutter attached to the carriage is inclined with respect to the first cutter so that a first end in the first direction of the second cutter is farther away from the first cutter in a second direction crossing the first direction than a second end in the first direction of the second cutter is, at the contact position; and
in a case where the recording medium is cut, the carriage is configured to:
move the second cutter in a cutting direction being a direction from the first end toward the second end in the first direction of the second cutter; and
move the second cutter in a direction opposite to the cutting direction, after cutting of the recording medium is completed.

7. The recording apparatus according to claim 4, wherein:
the blade of the first cutter extends along a first direction; and
the contact part is supported by the casing in a state that the contact part projects toward the second cutter, in a second direction crossing the first direction, beyond the first cutter.

8. The recording apparatus according to claim 7, wherein:
the blade of the first cutter has a cutting area configured to cooperate with the blade of the second cutter to cut the recording medium;
the second cutter attached to the carriage is inclined with respect to the first cutter so that a first end in the first direction of the second cutter is farther away from the first cutter in the second direction than a second end in the first direction of the second cutter is, at the contact position;
in a case where the recording medium is cut, the carriage is configured to:
move the second cutter in a cutting direction being a direction from the first end toward the second end in the first direction of the second cutter; and
move the second cutter in a direction opposite to the cutting direction after cutting of the recording medium is completed; and
an end of a projecting part, of the contact part, which projects toward the second cutter in the second direction beyond the first cutter, is located more closely to the first cutter than the first end of the second cutter facing the cutting area of the first cutter is.

9. The recording apparatus according to claim 8, wherein a corner part at a downstream end in the cutting direction of the projecting part of the contact part has a curved part.

10. The recording apparatus according to claim 4, wherein:
the blade of the first cutter extends along a first direction, and has a cutting area configured to cooperate with the blade of the second cutter to cut the recording medium and a non-cutting area disposed side by side with the cutting area in the first direction;
the cutting area is located farther away from the second cutter positioned at the non-contact position in a second direction crossing the first direction than the non-cutting area is; and
the contact part is a raised part, an end of the raised part defining a boundary between the cutting area and the non-cutting area.

11. The recording apparatus according to claim 10, wherein:
the second cutter is a disc-shaped rotary blade;
the second cutter attached to the carriage is inclined with respect to the first cutter so that a first end in the first direction of the second cutter is farther away from the first cutter in the second direction than a second end in the first direction of the second cutter is, at the contact position;
in a case where the recording medium is cut, the carriage is configured to:
move the second cutter in a cutting direction being a direction from the first end toward the second end in the first direction of the second cutter; and
move the second cutter in a direction opposite to the cutting direction after cutting of the recording medium is completed;
an inclined surface is formed at a downstream end in the cutting direction of the raised part, the inclined surface being inclined away from the second cutter positioned at the non-contact position in the second direction as the inclined surface extends in the cutting direction;
an upstream end in the cutting direction of the inclined surface is located farther away in the second direction from the cutting area than the first end of the second cutter is, in a case where the second cutter attached to the carriage is positioned at the contact position; and
an inclination angle of the inclined surface is greater than an inclination angle of the second cutter attached to the carriage and positioned at the contact position, and is equal to or smaller than twice the inclination angle of the second cutter, the inclination angle of the inclined surface being an acute angle defined between the inclined surface and the cutting area of the first cutter, the inclination angle of the second cutter being an acute angle defined between the second cutter positioned at the contact position and the cutting area of the first cutter.

12. The recording apparatus according to claim 4, wherein:
the blade of the first cutter extends along a first direction; and
in a case where the recording medium is cut, the carriage is configured to move the second cutter from the non-contact position in a cutting direction.

13. The recording apparatus according to claim 1, wherein the casing includes:
an opening via which the second cutter is to be attached to the carriage; and
a cover configured to move to a closed position at which the cover covers the opening and an open position at which the cover does not cover the opening, and
the recording apparatus further comprises a controller configured to move the carriage to the non-contact position depending on moving of the cover to the open position.

14. A cutter attachment method for a recording apparatus, wherein:
the recording apparatus includes a conveying unit, a recording unit, a first cutter, and a casing;
the recording apparatus is configured to convey a recording medium by the conveying unit, record an image on the conveyed recording medium by the recording unit, and cut the conveyed recording medium by the first cutter;
the first cutter is supported by the casing;
a second cutter configured to cooperate with the first cutter to cut the recording medium is attachable to a carriage supported by the casing; and
the carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position,
the method comprising:
moving the carriage to the non-contact position; and
attaching the second cutter to the carriage positioned at the non-contact position.

15. A recording apparatus comprising:
a conveying unit;
a recording unit;
a first cutter; and
a casing, wherein:
the recording apparatus is configured to convey a recording medium by the conveying unit, record an image on the conveyed recording medium by the recording unit, and cut the conveyed recording medium by the first cutter;
the first cutter is supported by the casing;
a second cutter configured to cooperate with the first cutter to cut the recording medium is attachable to a carriage supported by the casing;
the carriage is moveable to a contact position and a non-contact position, a blade of the second cutter attached to the carriage being in contact with a blade of the first cutter in a case where the carriage is positioned at the contact position, the blade of the second cutter attached to the carriage being separated from the blade of the first cutter in a case where the carriage is positioned at the non-contact position; and
the second cutter is attachable to the carriage positioned at the non-contact position.
